(19) United States
(12) Patent Application Publication
(10) Pub. No.: US 2006/0190460 A1
(43) Pub. Date: Aug. 24, 2006

(54) Method and mechanism of handling reporting transactions in database systems

(75) Inventors: Sashikanth Chandrasekaran, San Jose, CA (US); Angelo Pruscino, Los Altos, CA (US)

Correspondence Address: BINGHAM, MCCUTCHEN LLP, THREE EMBARCADERO CENTER, 18 FLOOR, SAN FRANCISCO, CA, 94111-4067, US

(73) Assignee: ORACLE INTERNATIONAL CORPORATION, REDWOOD SHORES, CA (US)

(21) Appl. No.: 11/061,152

(22) Filed: Feb. 18, 2005

(51) Int. Cl. G06F 17/00

(52) U.S. Cl. 707/100

(57) ABSTRACT

Disclosed are improved methods, systems, and mediums for handling reporting transactions in database systems. In some embodiments, database snapshots are used to carry out reporting transactions on a failover node concurrently with execution of non-reporting transactions on a primary node.

### BACKGROUND AND SUMMARY

The present invention is related to database systems. More particularly, the present invention is directed to a method and mechanism of handling reporting transactions in database systems.

Many database systems employ failover clusters to ensure high availability, which is crucial in today's fast paced marketplace. In a failover cluster, a database is linked to a primary node and at least one failover node (also known as the spare node). Applications, such as database and web servers, run on the primary node until it malfunctions. When that occurs, the applications are restarted on the failover node. Since the failover node and the primary node belong to a single cluster, standard heartbeat mechanisms can be used to detect failure of the primary node.

One problem with failover clusters is that the failover node cannot be used concurrently with the primary node. As such, it may be difficult to justify the cost of purchasing additional hardware that is used only when the primary hardware fails. Certain parallel database systems solve this problem by employing an active/active cluster where two or more nodes can concurrently access the database in the cluster. The active/active cluster, however, requires complex concurrency control mechanisms to ensure that the database is consistent in the presence of concurrent reads and modifications from all of the nodes in the cluster.

Another problem users face is the need to run mixed workloads, where reporting transactions are executed concurrently with other transactions. Ideally, real-time reporting is provided by each reporting transaction, i.e., results from the latest updates are used by queries in the transaction. In addition, users prefer to run the reporting transactions separately to avoid hardware resource competition (e.g., for CPU or memory) between the non-reporting and reporting transactions.

For database systems that do not support active/active clustering, a replicated database can be created and used for reporting. However, because a replicated database is an entire copy of the primary database, this solution doubles storage costs. Additionally, a replicated database often lags behind the primary database as it may not be feasible to instantaneously replicate changes in the primary database. Even if instantaneous replication were feasible, throughput on the primary database would be significantly affected since every commit on the primary database would need to be synchronously replicated to the reporting database.

Hence, there is a need for a method and mechanism to address these and other issues regarding the execution of reporting transactions in database systems utilizing failover clusters.

Embodiments of the present invention provide improved methods, systems, and mediums for handling reporting transactions in database systems. According to an embodiment, a snapshot of a database is taken. The database is linked to a primary node and a failover node. One or more non-reporting transactions are then executed on the primary node and the snapshot is utilized to carry out a reporting transaction on the failover node concurrently with the execution of the one or more non-reporting transactions on the primary node.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

The accompanying drawings are included to provide a further understanding of the invention and, together with the Detailed Description, serve to explain the principles of the invention.

FIG. 1 is a flow chart of a method of handling reporting transactions in database systems according to an embodiment of the invention.

FIG. 2 illustrates execution of a reporting transaction in a failover cluster according to one embodiment of the invention.

FIG. 3 depicts a process flow of a method for handling reporting transactions in database systems according to another embodiment of the invention.

FIG. 4 is an example of how a reporting transaction is handled in a cluster according to another embodiment of the invention.

FIG. 5 shows one embodiment of a method of handling reporting transactions in database systems.

FIG. 6 depicts a cluster with multiple failover nodes.

FIG. 7 illustrates another embodiment of a method for handling reporting transactions in database systems.

FIG. 8 shows sample database system.

FIG. 9 is a process flow of a method for handling reporting transactions in database systems according to a further embodiment of the invention.

FIG. 10 depicts execution of multiple reporting and non-reporting transactions in a failover cluster according to a further embodiment of the invention.

FIG. 11 is a diagram of a system architecture with which embodiments of the present invention can be implemented.

### DETAILED DESCRIPTION

Handling of reporting transactions in database systems is disclosed. Rather than employ an active/active cluster, which requires complex coherency and routing mechanisms, or have a separate replicated database, which entails purchasing additional hardware, with potentially outdated data, reporting transactions are executed on a failover node using database snapshots concurrently with non-reporting transactions running on a primary node. This utilizes the failover node, which would otherwise remain idle, and provides near real-time reporting when the latest snapshots are used.

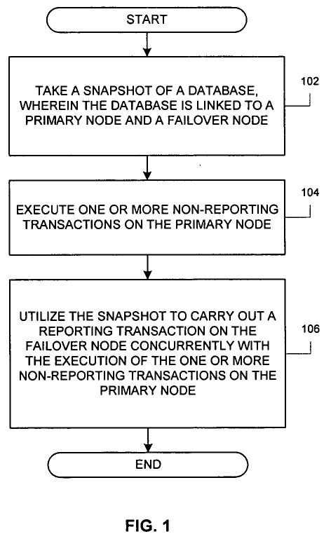

Illustrated in FIG. 1 is a method of handling reporting transactions in database systems. At 102, a snapshot of a database is taken. The database is linked to a primary node and a failover node. In some embodiments, only the primary node is allowed to modify the database. Client connections could be configured to direct all reporting transactions to the failover node and all other transactions to the primary node. It may also be possible for the failover node to automatically route transactions that could potentially modify the database to the primary node. This routing can be done by marking a transaction as READ-WRITE or READ-ONLY, which identifies whether the session will be modifying the database.

One or more non-reporting transactions are then executed on the primary node (104) and the snapshot is utilized to carry out a reporting transaction on the failover node concurrently with the execution of the one or more non-reporting transactions on the primary node (106). Each of the reporting and non-reporting transaction comprises one or more queries. And although non-reporting transaction may be read-write or read-only transactions, reporting transactions are usually read-only transactions.

A snapshot is a point-in-time copy of the database and shares the same disk space as the database, except for database blocks that are modified after the snapshot is taken. This can be accomplished through a standard copy-on-write mechanism where changed blocks are written to a new location so that the snapshot remains unmodified. Since snapshots are read-only and cannot be modified by the primary node, queries running on the failover node will return results that are consistent with the snapshot used without requiring coordination with the primary node. And because a snapshot is consistent and for the entire database (i.e., indexes in the snapshot and tables referenced in queries are all consistent), existing query execution engines need not be modified. Various snapshot methodologies are available and can be implemented on a file, application, system, or database level. For example, a description on creating file-level snapshot can be found at http://www.netapp.com/tech library/3002.html.

Snapshots are relatively cheap to create both in terms of disk space and CPU usage since they use the same disk storage as the database for all unchanged data. As such, database systems can be configured to take a snapshot fairly frequently, e.g., every 10 seconds. However, it is also possible for a database system to generate a snapshot in response to a user command, e.g., based on the quality of service desired by the reporting session or other such metrics. Using the most current snapshot to carry out the reporting transaction on the failover node will provide near real-time reporting as the latest updates will be used by queries in the reporting transaction. The user, however, may also be allowed to specify the use of a snapshot that is older than the most recent one taken.

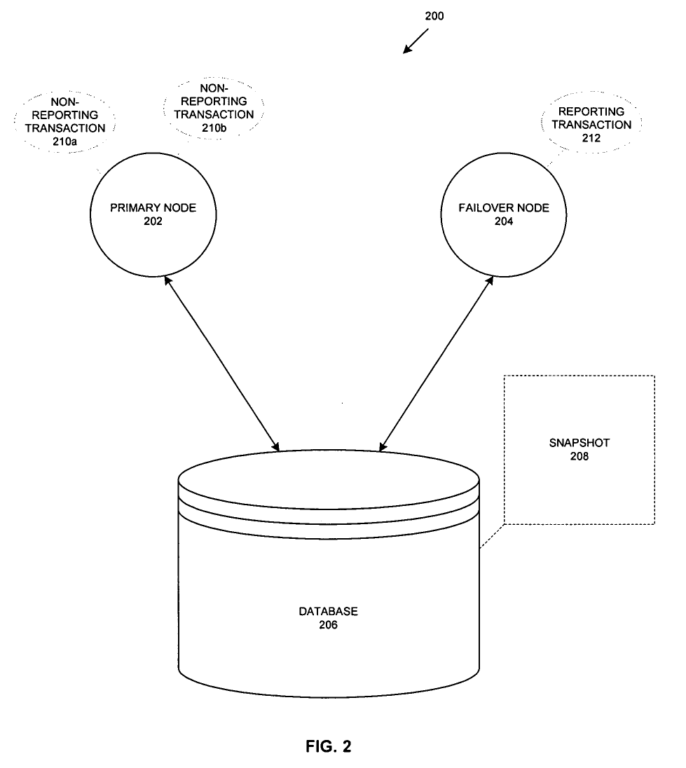

FIG. 2 depicts a cluster 200 with a primary node 202, a failover node 204, and a database 206. A snapshot 208 of database 206 has been taken. While a plurality of non-reporting transactions 210a and 210b are running on primary node 202, snapshot 208 is used to execute a reporting transaction 212 on failover node 204. In some embodiments, non-reporting transactions 210a and 210b and reporting transaction 212 are part of a workload.

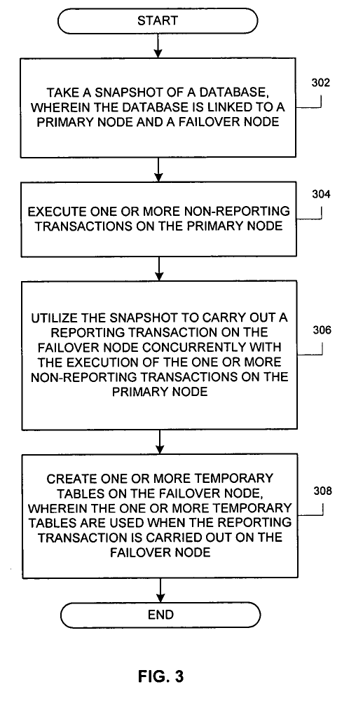

Shown in FIG. 3 is a process flow of a method for handling reporting transactions in database systems. According to the embodiment, a snapshot is taken of a database linked to a primary node and a failover node (302). At 304, one or more non-reporting transactions are executed on the primary node. The snapshot is utilized to carry out a reporting transaction on the failover node concurrently with the execution of the one or more non-reporting transactions on the primary node (306). One or more temporary tables are then created and used when the reporting transaction is carried out on the failover node (308).

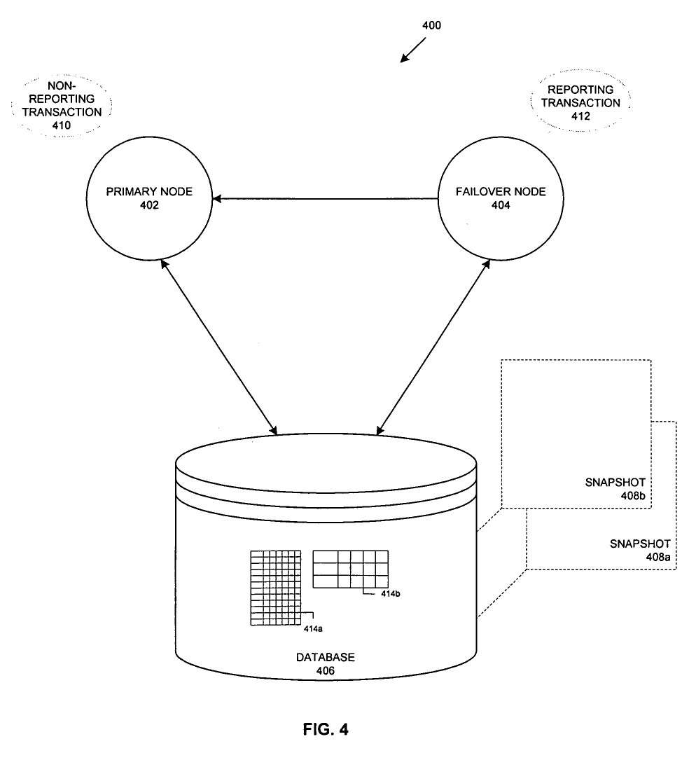

A cluster 400 is illustrated in FIG. 4. Cluster 400 includes a primary node 402, a failover node 404, and a database 406. In the example, a snapshot 408a is taken and used to execute a reporting transaction 412 on failover node 404 while a non-reporting transaction 410 is running on primary node 402. During execution of reporting transaction 412, temporary tables 414a and 414b are created through a query script in transaction 412 to store temporary results. These temporary tables 414a and 414b are transparently forwarded to primary node 402, which then allocates space in database 406 for temporary tables 414a and 414b. Changes that are subsequently saved in temporary tables 414a and 414b at failover node 404 need not be forwarded to primary node 402.

In FIG. 4, a new snapshot 408b of database 406 is taken to allow subsequent queries in reporting transaction 412 to access temporary tables 414a and 414b. However, in other embodiments, less than all of the temporary tables created will be kept for access by subsequent queries. Thus, after completion of a query, the failover node may delete a temporary table and forward the deletion to the primary node in order to release the database space allocated for the table.

To ensure consistent results, a single query will usually use the same snapshot. However, as seen in the example of FIG. 4, a subsequent query within the same session or transaction may use the same snapshot as or a more recent snapshot than the one used by a previous query.

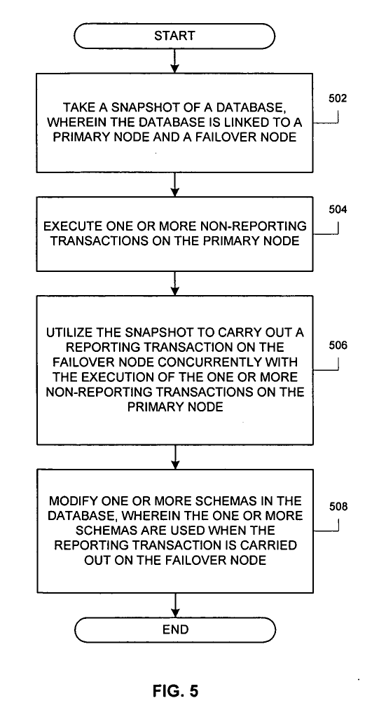

Depicted in FIG. 5 is another method of handling reporting transactions in database systems. A snapshot of a database is taken at 502. In the embodiment, the database is linked to a primary node and a failover node. One or more non-reporting transactions are then executed on the primary node (504) and the snapshot is utilized to carry out a reporting transaction on the failover node concurrently with the execution of the one or more non-reporting transactions on the primary node (506). At 508, one or more schemas in the database are modified and used when the reporting transaction is carried out on the failover node. The one or more schemas may have been created on the primary node and “marked” or “reserved” for use by the reporting transaction on the failover node. In addition, changes to the one or more schemas may be made without coordinating with the primary node.

A database schema is a collection of objects. Schema objects include, but are not limited to, e.g., tables, views, sequences, and stored procedures. Tables are generally the basic unit of organization in a database and comprise data stored in respective rows and columns. Views are custom-tailored presentations of data in one or more tables. Views derive their data from the tables on which they are based, i.e., base tables. Base tables, in turn, can be tables, or can themselves be views. An example of a view is a table minus two of the columns of data of the table.

Sequences are serial lists of unique numbers identifying numeric columns of one or more database tables. They generally simplify application programming by automatically generating unique numerical values for the rows of a single table, or multiple tables. With the use of sequences, more than one user may enter data to a table at generally the same time. A stored procedure is generally a set of computer statements grouped together as an executable unit to perform a specific task.

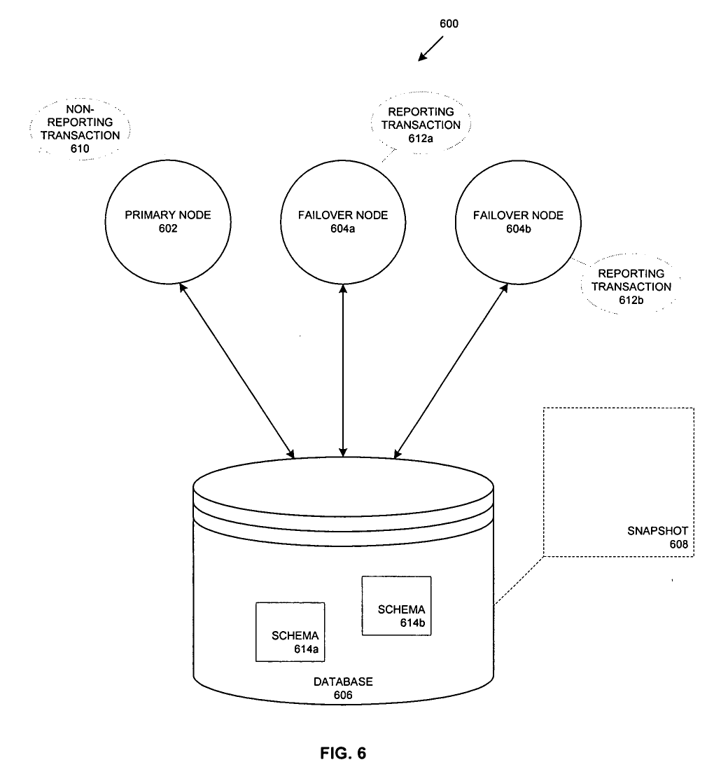

FIG. 6 shows a cluster 600 with a primary node 602, two failover nodes 604a and 604b, and a database 606. A snapshot 608 has been taken of database 606. In the embodiment, schemas 614a and 614b within database 606 are available to failover nodes 604a and 604b in read-write mode, unlike the rest of database 606, which is only open to failover nodes 604a and 604b through snapshot 608. Under this situation, schemas 614a and 614b can be modified by reporting transactions 612a and 612b running on failover nodes 604a and 604b, respectively. Since data contained in schemas 614a and 614b is not shared between failover nodes 604a-604b and primary node 602, non-reporting transaction 610 executing on primary node 602 cannot access schemas 614a and 614b in database 606.

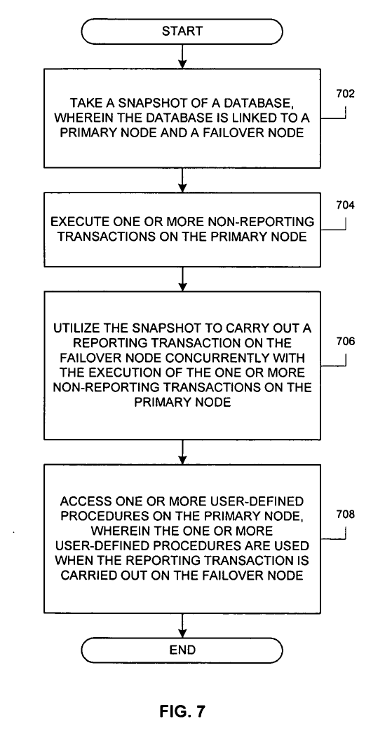

A flowchart of a method for handling reporting transactions in database systems is illustrated in FIG. 7. At 702, a snapshot of a database linked to a primary node and a failover node is taken. One or more non-reporting transactions are executed on the primary node at 704. The snapshot is then utilized to carry out a reporting transaction on the failover node concurrently with the execution of the one or more non-reporting transactions on the primary node (706).

In the embodiment, one or more user-defined procedures on the primary node are accessed and used when the reporting transaction is carried out on the failover node (708). User-defined procedures are commonly used to make it easier to prepare complex reports and are usually created and compiled on the primary node. These procedures can be accessed from the failover node just like any other database object.

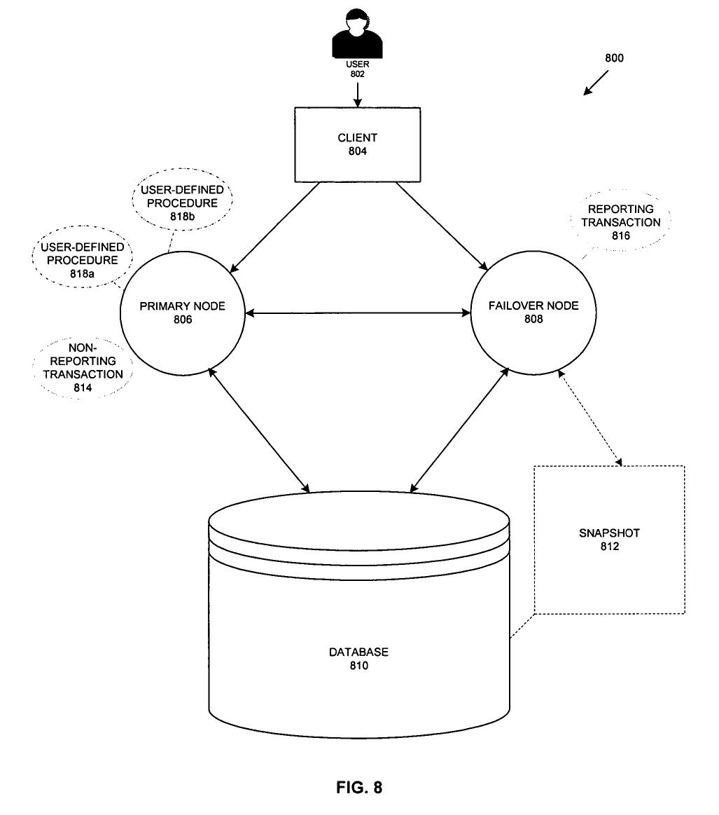

A database system 800 is depicted in FIG. 8. Although the figure only shows a user 802, a client 804, a primary node 806, a failover node 808, and a database 810, system 800 may include other clusters, nodes, users, databases, and clients. In the example, user 802, through client 804, has defined procedures 818a and 818b on primary node 806. After a snapshot 812 is taken of database 810, a reporting transaction 816 is executed on failover node 808, concurrently with the running of a non-reporting transaction 814 on primary node 806, using snapshot 812 and user-defined procedures 818a and 818b. As illustrated in FIG. 8, the use of snapshot 812, unlike user-defined procedures 818a and 818b, is direct, i.e., snapshot 812 is used without going through primary node 806.

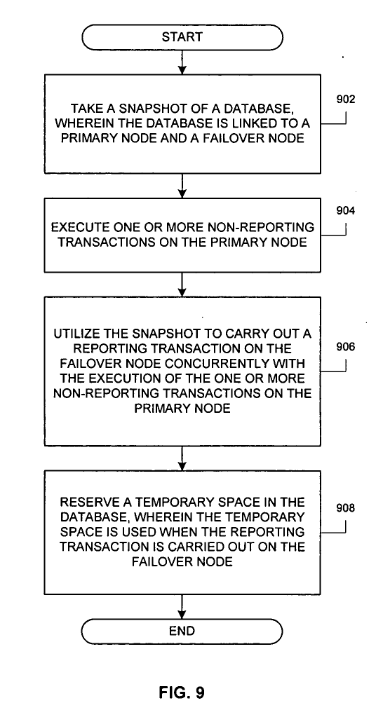

Another method of handling reporting transactions in database systems is shown in FIG. 9. According to the method, a snapshot of a database is taken at 902. The database is linked to a primary node and a secondary node. One or more non-reporting transactions are then executed on the primary node at 904 and the snapshot is utilized to carry out a reporting transaction on the failover node concurrently with the execution of the one or more non-reporting transactions on the primary node at 906. A temporary space in the database is reserved and used when the reporting transaction is carried out on the failover node (908).

To reserve temporary space in a database, a failover node can send a message to a primary node since the reservation usually requires catalog changes that are performed by the primary node to avoid coherency issues. Once the scratch disk space has been reserved for the failover node, writing to the temporary space itself can be performed without intervention from the primary node. The scratch space permits temporary files to be created. These temporary files are sometimes needed to store results of temporary operations that do not fit in main memory, e.g., intermediate results in sorts, hash tables used in JOIN methods, etc.

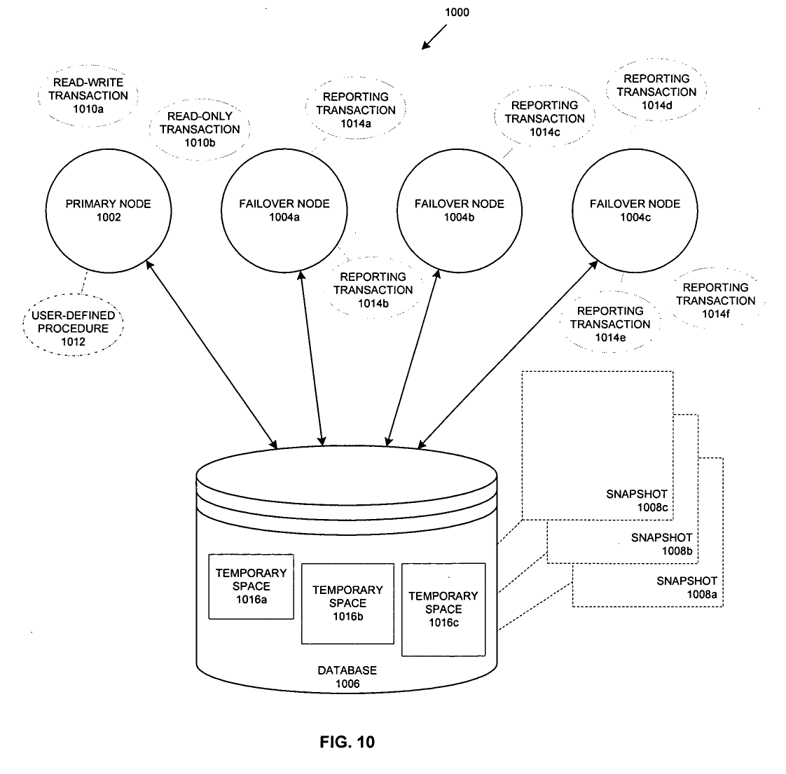

FIG. 10 illustrates a cluster 1000 with a primary node 1002 and three failover nodes 1004a, 1004b, and 1004c, all of which are linked to a database 1006. In the figure, a user-defined procedure 1012 can be found on primary node 1002 along with a read-write transaction 1010a and a read-only transaction 1010b. Reporting transactions 1014a and 1014b are running on failover node 1004a. Additionally, a reporting transaction 1014c is running on failover node 1004b, while reporting transactions 1014d, 1014e, and 1014f are running on failover node 1004c. Three snapshots 1008a, 1008b, and 1008c of database 1006 have been taken at different times. Each of the reporting transactions can be executed using one of the snapshots. Reporting transactions on the same failover node, however, need not utilize the same snapshot. For instance, reporting transactions 1014d, 1014e, and 1014f on failover node 1004c can each use a different snapshot 1008.

As depicted in FIG. 10, three temporary spaces 1016a, 1016b, and 1016c have been reserved in database 1006 for failover nodes 1004a, 1004b, and 1004c, respectively. Each of the failover nodes 1004a, 1004b, and 1004c sent a request to primary node 1002 to reserve their respective scratch space. In other embodiments, failover nodes 1004a, 1004b, and 1004c may share one or more temporary spaces.

### SYSTEM ARCHITECTURE OVERVIEW

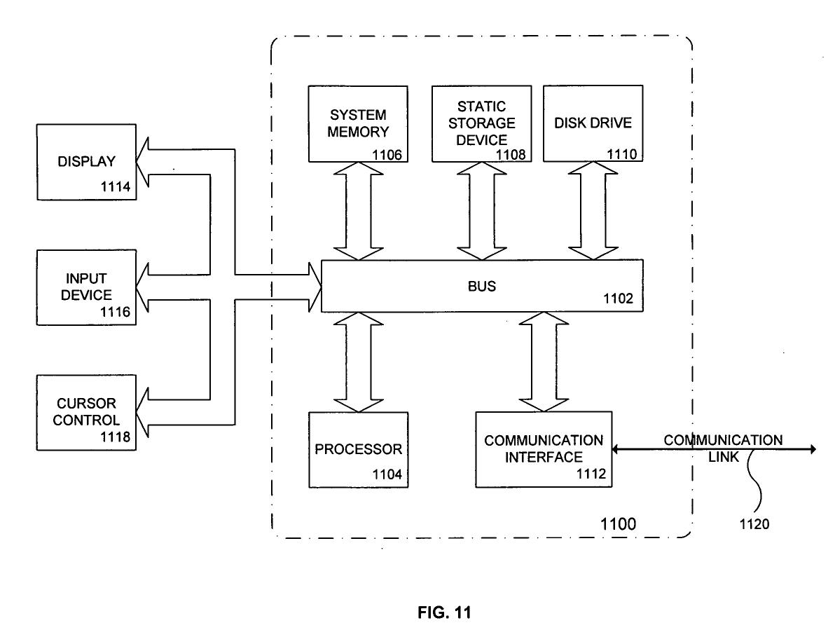

FIG. 11 is a block diagram of a computer system 1100 suitable for implementing an embodiment of the present invention. Computer system 1100 includes a bus 1102 or other communication mechanism for communicating information, which interconnects subsystems and devices, such as processor 1104, system memory 1106 (e.g., RAM), static storage device 1108 (e.g., ROM), disk drive 1110 (e.g., magnetic or optical), communication interface 1112 (e.g., modem or ethernet card), display 1114 (e.g., CRT or LCD), input device 1116 (e.g., keyboard), and cursor control 1118 (e.g., mouse or trackball).

According to one embodiment of the invention, computer system 1100 performs specific operations by processor 1104 executing one or more sequences of one or more instructions contained in system memory 1106. Such instructions may be read into system memory 1106 from another computer readable medium, such as static storage device 1108 or disk drive 1110. In alternative embodiments, hard-wired circuitry may be used in place of or in combination with software instructions to implement the invention.

The term “computer readable medium” as used herein refers to any medium that participates in providing instructions to processor 1104 for execution. Such a medium may take many forms, including but not limited to, non-volatile media, volatile media, and transmission media. Non-volatile media includes, for example, optical or magnetic disks, such as disk drive 1110. Volatile media includes dynamic memory, such as system memory 1106. Transmission media includes coaxial cables, copper wire, and fiber optics, including wires that comprise bus 1102. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In an embodiment of the invention, execution of the sequences of instructions to practice the invention is performed by a single computer system 1100. According to other embodiments of the invention, two or more computer systems 1100 coupled by communication link 1120 (e.g., LAN, PTSN, or wireless network) may perform the sequence of instructions required to practice the invention in coordination with one another.

Computer system 1100 may transmit and receive messages, data, and instructions, including program, i.e., application code, through communication link 1120 and communication interface 1112. Received program code may be executed by processor 1104 as it is received, and/or stored in disk drive 1110, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method of handling reporting transactions in database systems, the method comprising:
taking a snapshot of a database, wherein the database is linked to a primary node and a failover node;
executing one or more non-reporting transactions on the primary node; and
utilizing the snapshot to carry out a reporting transaction on the failover node concurrently with the execution of the one or more non-reporting transactions on the primary node.

2. The method of claim 1, further comprising:
creating one or more temporary tables on the failover node, wherein the one or more temporary tables are used when the reporting transaction is carried out on the failover node.

3. The method of claim 2, wherein the one or more temporary tables are created through a query script in the reporting transaction.

4. The method of claim 2, wherein at least one of the one or more temporary tables is accessible to more than one query in the reporting transaction.

5. The method of claim 1, further comprising:
modifying one or more schemas in the database, wherein the one or more schemas are used when the reporting transaction is carried out on the failover node.

6. The method of claim 5, wherein the one or more schemas are not accessible to the one or more non-reporting transactions executing on the primary node.

7. The method of claim 5, wherein at least one of the one or more schemas includes one or more tables.

8. The method of claim 1, further comprising:
accessing one or more user-defined procedures on the primary node, wherein the one or more user-defined procedures are used when the reporting transaction is carried out on the failover node.

9. The method of claim 1, further comprising:
reserving a temporary space in the database, wherein the temporary space is used when the reporting transaction is carried out on the failover node.

10. The method of claim 1, wherein the primary node and the failover node are part of a cluster.

11. The method of claim 10, wherein the cluster includes one or more additional failover nodes.

12. The method of claim 1, wherein at least one of the one or more non-reporting transactions is a read-write transaction.

13. The method of claim 1, wherein the reporting transaction and the one or more non-reporting transactions are part of a workload.

14. The method of claim 1, wherein the reporting transaction provides near real-time reporting.

15. The method of claim 1, wherein only the primary node can modify the database.

16. The method of claim 1, wherein the snapshot is taken in response to a user command.

17. The method of claim 1, wherein the snapshot is read-only.

18. The method of claim 1, wherein the snapshot cannot be modified by the primary node.

19. The method of claim 1, wherein the snapshot and the database share a disk space.

20. The method of claim 1, wherein the snapshot is the most current.

21. The method of claim 1, wherein the snapshot is directly used to carry out the reporting transaction on the failover node.

22. A computer program product that includes a computer readable medium, the computer readable medium comprising instructions which, when executed by a processor, causes the processor to execute a process for handling reporting transactions in database systems, the process comprising:
taking a snapshot of a database, wherein the database is linked to a primary node and a failover node;
executing one or more non-reporting transactions on the primary node; and
utilizing the snapshot to carry out a reporting transaction on the failover node concurrently with the execution of the one or more non-reporting transactions on the primary node.

23. A system for handling reporting transactions in database systems, the system comprising:
means for taking a snapshot of a database, wherein the database is linked to a primary node and a failover node;
means for executing one or more non-reporting transactions on the primary node; and
means for utilizing the snapshot to carry out a reporting transaction on the failover node concurrently with the execution of the one or more non-reporting transactions on the primary node.
